(19) United States
(12) Patent Application Publication
(10) Pub. No.: US 2006/0055789 A1
(43) Pub. Date: Mar. 16, 2006

(54) Menu image display method and electronic information equipment

(76) Inventors: Akiyoshi Jin, Yokohama-shi (JP); Kunio Otsuka, Yokohama-shi (JP); Naoyuki Nogushi, Minato-ku (JP); Soushi Takita, Kawasakishi (JP)

Correspondence Address: NATH & ASSOCIATES, 112 South West Street, Alexandria, VA, 22314, US

(21) Appl. No.: 11/222,844

(22) Filed: Sep. 12, 2005

(30) Foreign Application Priority Data
Sep. 13, 2004 (JP) P2004-265449
May 2, 2005 (JP) P2005-133952

(51) Int. Cl. H04N 5/228; H04N 5/222; H04N 5/445; H04N 9/64; H04N 5/66

(52) U.S. Cl. 348/208.12; 348/719; 348/333.05; 348/739; 348/563

(57) ABSTRACT

When a menu image transition occurs from a first hierarchical level to a second hierarchical level and to a third hierarchical level, boundary lines B1 and B2, which are near but not in contact each other, are displayed on a display screen to divide it into three areas, R1, R2, and R3. A triangle mark is displayed in area R1 to indicate that there is a higher hierarchical level. Areas R1 and R2 allow the user to recognize that there are the first and second hierarchical levels which are higher. Information (for example, thumbnail images) corresponding to the third hierarchical level is displayed in area R3.

### BACKGROUND OF THE INVENTION

1. Field of the Invention

The present invention relates to a menu image display method and electronic information equipment, and more particularly to a menu image display method and electronic information equipment that allows the user to easily recognize at which hierarchical level the user is currently performing operation in a hierarchically structured menu.

The present invention is widely applicable when the user performs operation on portable information equipment such as a video camera, a cellular phone, or a portable information terminal or on other various types of electronic information equipment, with a menu image of multiple hierarchy levels displayed on the screen.

2. Description of the Related Art

As one of typical examples of conventional operation that uses a display screen, the following describes an operation on a personal computer. FIG. 1 shows the configuration of a screen used for various settings or operations on a personal computer. A square window 102 is displayed in a screen 101 and, in the top of the screen, tabs 103 are provided. “SETTING”, “IMAGE”, and “EFFECT” are shown in the figure as an example of the tabs 103 to indicate to which major items the currently displayed content in the window 102 belongs.

The tab 103 (in the figure, “IMAGE” tab 103) corresponding to the currently displayed content comes right above the window 102, which is a content display part, to make them visually recognized as if they were on one sheet of paper. Other major item tabs (“SETTING” and “EFFECT” tabs 103) are displayed with a boundary line between those tabs 103 and the window 102 to make them recognized as if those major items were drawn on other sheets of paper currently not displayed. FIG. 1 shows an example in which the operation content of portable information equipment, which will be described later in the embodiments of the present invention, is displayed in the conventional display method.

In this display method, the structure of the screen is that the content (major item) written in the tab 103 is the first hierarchical level, and the content displayed in the window 102 displayed when each tab 103 is selected is a second hierarchical level. In the example shown in FIG. 1, the window 102 of the major item “IMAGE” is divided into intermediate items, “SCENE” and “PLAYLIST”, each of which has minor items. Some of those minor items complete the operation in this window 102. For example, in “NEW CREATION” under “PLAYLIST” in the example shown in FIG. 1, the user enters a new playlist name in a box (fill-in area) 104 and presses a CREATION button 105; similarly, in “CHANGING NAME”, the user opens the list of playlist names to display a playlist to be changed, rewrites the name, and presses an OK button 106.

On the other hand, some items require another screen to continue the operation. For example, for the minor items “PROTECT” and “EDIT” under “SCENE”, only the buttons 107 and 108 used for displaying a window of the screen are displayed. For example, when the user presses the “To protect image specification screen” button 107 as an action to be taken for “PROTECT”, a window 109 including a plurality of thumbnails is displayed as shown in FIG. 2 to allow the user to protect a desired image.

Another hierarchical representation specifically designed for use on portable information equipment is proposed in which the hierarchy is displayed horizontally on the screen (for example, see Japanese Patent Laid-Open Publication No. 2001-265477).

Meanwhile, in the conventional menu image display method, if small-letter information is displayed on the display (display screen) such as the one installed in portable information equipment that is an example of electronic information equipment, the user finds it difficult to read and inconvenient to use. A problem to be solved is to present hierarchically structured selection items in an easy to understand format.

In the examples of conventional displays shown in FIG. 1 and FIG. 2, only a small tab 103 can be displayed on the small display screen of portable information equipment and, therefore, there is a limit to the presentation that enables the user to easily find at which hierarchical level the content is displayed now. In particular, when the operation screen is displayed as the window 109 different from the window 102 that has the tabs 103 as shown in FIG. 2, the previously displayed window 102 is hidden. Therefore, the user relies only on his or her memory of the operation to understand to which hierarchy level the newly displayed window 109 belongs. This sometimes causes confusion especially when the user mistakenly displays a new window.

The invention disclosed in Japanese Patent Laid-Open Publication No. 2001-265477 is effective for electronic information equipment having a somewhat large display. However, displaying items at multiple hierarchical levels side by side on portable information equipment having a very small display, for example, 2 inches or smaller, still involves a problem that each item cannot be recognized clearly.

### SUMMARY OF THE INVENTION

In view of the foregoing, it is an object of the present invention to provide a menu image display method and electronic information equipment that allow the user to easily recognize at which hierarchical level the user is performing operation when operating electronic information equipment with operation items displayed hierarchically and thereby to help the user to perform operation reliably.

To achieve the above objects, there is provided a menu image display method for displaying a menu image on a screen, the menu image composed of a plurality of hierarchical levels, the method comprising the steps of: in response to a key operation for displaying a first hierarchical level menu on the screen, displaying a first boundary image and a first identification image, which indicates that there is a second hierarchical level lower than the first hierarchical level, on the screen and, at the same time, generating a first display state in which a plurality of items constituting the first hierarchical level menu are displayed in one of areas delimited by the first boundary image on the screen; in response to a key operation for selecting one of the plurality of items constituting the first hierarchical level menu to make a transition to the second hierarchical level, displaying second and third boundary images, a second identification image which indicates that there is the first hierarchical level, and a third identification image which indicates that there is a third hierarchical level lower than the second hierarchical level on the screen and, at the same time, generating a second display state in which a plurality of items constituting the second hierarchical level menu are displayed in a first intermediate area appearing between the second and third boundary images; and in response to a key operation for selecting one of the plurality of items constituting the second hierarchical level menu to make a transition to the third hierarchical level, displaying fourth and fifth boundary images, which are near but not in contact each other, and a fourth identification image which indicates that there is a hierarchical level higher than the third hierarchical level on the screen and, at the same time, generating a third display state in which information corresponding to the third hierarchical level is displayed in an area other than a second intermediate area appearing between the fourth and fifth boundary images.

When the user performs operation on operation items divided into a plurality of hierarchical levels, the menu image display method according to the present invention allows the user to easily recognize at which hierarchical level the user is performing operation even in a small screen and therefore to perform reliable operation.

In a preferred embodiment of the present invention, when a transition occurs from the first display state to the second display state, the first boundary image is moved on the screen to change into the second boundary image.

In a preferred embodiment of the present invention, the third boundary image is displayed at the same position as the first boundary image.

In a preferred embodiment of the present invention, the fourth boundary image is displayed at the same position as the second boundary image.

In a preferred embodiment of the present invention, when a transition occurs from the second display state to the third display state, the third boundary image is moved on the screen to change into the fifth boundary image.

In a preferred embodiment of the present invention, in the first display state, the first identification image is displayed in a first outer area which is another area delimited by the first boundary image on the screen, and in which the plurality of items constituting the first hierarchical level menu are not displayed.

In a preferred embodiment of the present invention, in the second display state, the second identification image is displayed in a second outer area positioned outside the first intermediate area and the third identification image is displayed in the same position as the first identification image in a third outer area that is opposed to the second outer area across the intermediate area.

In a preferred embodiment of the present invention, in the third display state, the fourth identification image is displayed in the same position as the second identification image in a fourth outer area which is positioned outside the second intermediate area and in which information corresponding to the third hierarchical level is not displayed.

In a preferred embodiment of the present invention, in the first and second display states, at least one of an item name of each item and an icon corresponding to the item name is displayed as the plurality of items and, in the second display state, at least one of an item name and an icon of an item in the first hierarchical level menu is also displayed, the item corresponding to the plurality of items in the second hierarchical level menu.

In a preferred embodiment of the present invention, in the second display state, information at the third hierarchical level is also displayed, the information corresponding to an item selected from the plurality of items.

To achieve the above objects, there is provided a electronic information equipment comprising a display screen (21) for displaying a menu image on the display screen, the menu image composed of a plurality of hierarchical levels, the equipment comprising: an operation unit (15) having one or more keys; first display means (14) that, in response to a key operation activated by one of the keys on the operation unit for displaying a first hierarchical level menu on the screen, displays a first boundary image and a first identification image, which indicates that there is a second hierarchical level lower than the first hierarchical level, on the display screen and, at the same time, generates a first display state in which a plurality of items constituting the first hierarchical level menu are displayed in one of areas delimited by the first boundary image on the display screen; second display means (14) that, in response to a key operation activated by one of the keys on the operation unit for selecting one of the plurality of items constituting the first hierarchical level menu to make a transition to the second hierarchical level, displays second and third boundary images, a second identification image which indicates that there is the first hierarchical level, and a third identification image which indicates that there is a third hierarchical level lower than the second hierarchical level on the display screen and, at the same time, generates a second display state in which a plurality of items constituting the second hierarchical level menu are displayed in a first intermediate area appearing between the second and third boundary images; and third display means (14) that, in response to a key operation activated by one of the keys on the operation unit for selecting one of the plurality of items constituting the second hierarchical level menu to make a transition to the third hierarchical level, displays fourth and fifth boundary images, which are near but not in contact each other, and a fourth identification image which indicates that there is a hierarchical level higher than the third hierarchical level on the display screen and, at the same time, generates a third display state in which information corresponding to the third hierarchical level is displayed in an area other than a second intermediate area appearing between the fourth and fifth boundary images.

When the user performs operation on operation items divided into a plurality of hierarchical levels, the electronic information equipment according to the present invention allows the user to easily recognize at which hierarchical level the user is performing operation even in a small screen and therefore to perform reliable operation.

In a preferred embodiment of the present invention, the electronic information equipment further comprises first boundary image moving means for moving the first boundary image on the display screen to change the first boundary image into the second boundary image when a transition occurs from the first display state to the second display state.

In a preferred embodiment of the present invention, the second display means displays the third boundary image at the same position as the first boundary image.

In a preferred embodiment of the present invention, the third display means displays the fourth boundary image at the same position as the second boundary image.

In a preferred embodiment of the present invention, the electronic information equipment further comprises second boundary image moving means for moving the third boundary image on the screen to change the third boundary image into the fifth boundary image when a transition occurs from the second display state to the third display state.

In a preferred embodiment of the present invention, the first display means displays the first identification image in a first outer area which is another area delimited by the first boundary image on the screen, and in which the plurality of items constituting the first hierarchical level menu are not displayed.

In a preferred embodiment of the present invention, the second display means displays the second identification image in a second outer area positioned outside the first intermediate area and displays the third identification image in the same position as the first identification image in a third outer area that is opposed to the second outer area across the intermediate area.

In a preferred embodiment of the present invention, the third display means displays the fourth identification image in the same position as the second identification image in a fourth outer area which is positioned outside the second intermediate area and in which information corresponding to the third hierarchical level is not displayed.

In a preferred embodiment of the present invention, the first and second display means display at least one of an item name of each item and an icon corresponding to the item name as the plurality of items and, the second display means also displays at least one of an item name and an icon of an item in the first hierarchical level menu, the item corresponding to the plurality of items in the second hierarchical level menu.

In a preferred embodiment of the present invention, the second display means also displays information at the third hierarchical level, the information corresponding to an item selected from the plurality of items.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a diagram showing an example of a prior art;

FIG. 2 is a diagram showing an example of a prior art;

FIG. 3 is a block diagram showing a first embodiment;

FIG. 4 is a diagram showing an example of the first hierarchical level of a menu image in the first embodiment;

FIG. 5 is a diagram showing an example of the second hierarchical level of a menu image in the first embodiment;

FIG. 6 is a diagram showing an example of the third hierarchical level of a menu image in the first embodiment;

FIG. 7 is a perspective view showing an example of the external configuration of a shooting-type video camera in the first embodiment;

FIG. 8 is a diagram showing an example of objects used in a menu image in the first embodiment;

FIG. 9 is a diagram showing an example of transition among hierarchical levels in the first embodiment;

FIGS. 10A and 10B are diagrams showing an example of transition among hierarchical levels in the first embodiment using menu images;

FIG. 11 is a flowchart showing an example of display processing at the first hierarchical level of a menu image in the first embodiment;

FIG. 12 is a flowchart showing an example of display processing at the second hierarchical level of a menu image in the first embodiment;

FIG. 13 is a flowchart showing an example of display processing at the third hierarchical level of a menu image in the first embodiment;

FIGS. 14A-14C are diagrams showing an example of transition among hierarchical levels in a second embodiment using menu images;

FIG. 15 is a diagram showing a third embodiment.

FIGS. 16A-16C are diagrams showing an example of transition among hierarchical levels in a fourth embodiment using menu images;

FIG. 17 is a block diagram showing a fifth embodiment; and

FIG. 18 is a diagram showing an example of transition among hierarchical levels in a sixth embodiment using menu images.

### DESCRIPTION OF THE PREFERRED EMBODIMENTS

Embodiments of a menu image display method and electronic information equipment according to the present invention will be described below with reference to the attached drawings.

### First Embodiment

A first embodiment will be described with portable information equipment, such as a video camera, as an example of electronic information equipment.

<<Example of Operation Menu Screen and Function Operation>>

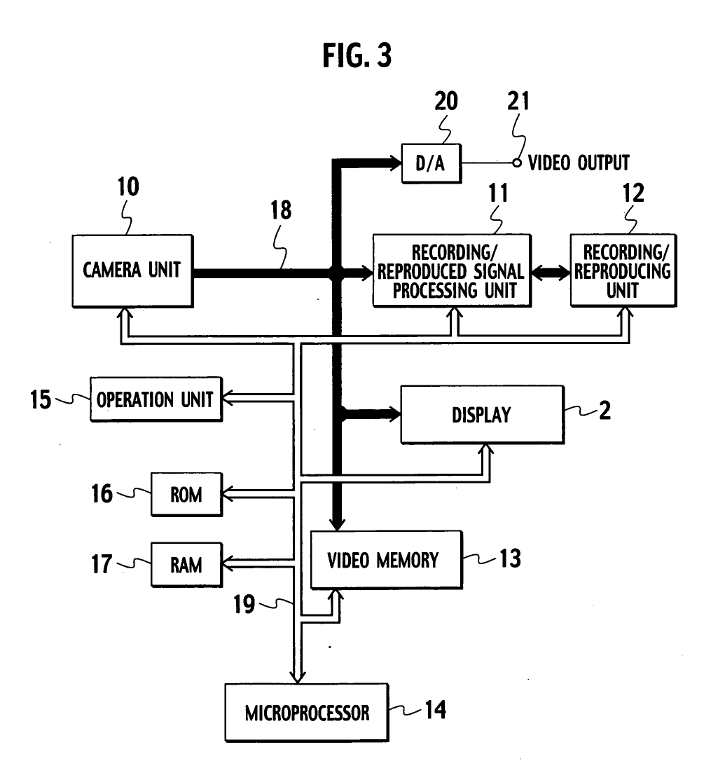

FIG. 3 shows an example of the hardware configuration of portable information equipment. The blocks shown in the figure are included in a shooting-type video camera 50 such as the one shown in FIG. 7. Referring to FIG. 3, a video shot by a camera unit 10 is converted by the camera unit 10 into a digital signal and, via a video signal bus 18, supplied to a recording/reproduced signal processing unit 11. The recording/reproduced signal processing unit 11 compresses and formats the received digital signal and supplies the digital signal to a recording/reproducing unit 12. The recording/reproducing unit 12 includes or stores a magnetic tape such as a DVC (Digital Video Cassette), a hard disk built-in card such as a Microdrive (registered trademark), a semiconductor memory card such as an SD card (registered trademark), or a recording medium (not shown) such as an optical disc. The digital signal received by the recording/reproducing unit 12 is recorded on a recording medium. Although not shown in the figure, the recording/reproducing unit 12 has a rotary head, a card attachment connector, or a disk drive according to the type of recording medium. The video signal bus 18 is connected to a D/A converter 20, which converts the digital video signal to an analog video signal for output from a video signal output terminal 21.

The video signal bus 18 is connected also to a display 2 and a video memory 13. The video signal, shot by the camera unit 10, is converted to an analog signal by a D/A converter, provided for the display but not shown in the figure, for displaying a video on the display 2. The display 2 comprises a display screen composed of a liquid crystal display panel that will be described later and a driving circuit that displays an image on the display screen. By storing a video signal, shot by the camera unit 10, once in the video memory 13, superimposing a superimpose signal created by a microprocessor 14 onto the video signal, and then returning the video signal to the video signal bus 18, the video signal on which various information is superimposed can also be displayed on the display 2, recorded on a recording medium, or output from the video signal output terminal 21. To reproduce the video signal recorded on the recording medium, the recording/reproduced signal processing unit 11 decompresses the compressed video signal to produce the reproduced video signal. The reproduced video signal is then output to the video signal bus 18 for display on the display 2 or for output from the video signal output terminal 21.

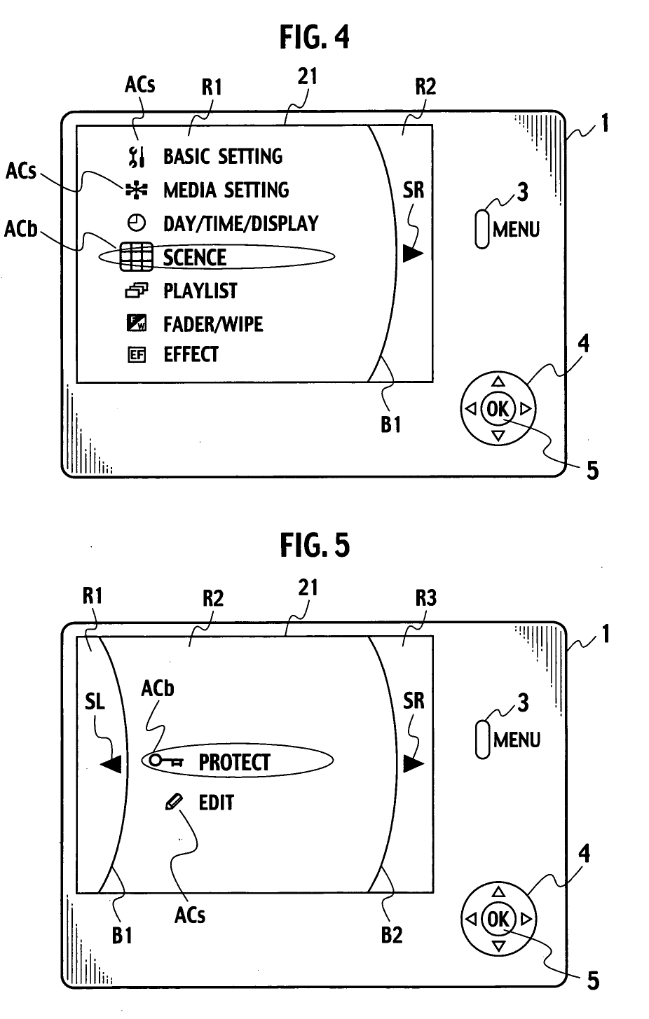

Portable information equipment (video camera 50), controlled by a microprocessor 14, has its components connected to the microprocessor 14 via a bus 19 for transfer of control signals and data. As shown in FIG. 4 to FIG. 7, an operation unit 15 comprises a menu key 3, cross keys 4, and an OK key 5. A user input from those user interfaces is sent to the microprocessor 14 via the bus 19. A ROM 16 stores programs and data used by the microprocessor 14. The microprocessor 14 uses a RAM 17, which is a temporary storage memory for various types of processing, as necessary for executing various types of processing. The microprocessor 14 executes the programs and uses data stored in the ROM 16 to create operation screen information (menu images of hierarchical levels) used in a first embodiment, which will be described later, and supplies the created information to the video memory 13 via the bus 19 for storing the information therein. Operation screen information stored in the video memory 13 is supplied to the display 2 via the video signal bus 18 and displayed and presented to the user. The ROM 16 may be in any form; for example, it may be a non-volatile RAM in which programs can be rewritten even after fabrication.

FIG. 4 shows a display screen 21 of the display 2 of the portable information equipment as well as the keys near to the display screen 21. The display screen 21 of the display 2 is provided on a case 1 of the portable information equipment, and the menu key 3, cross keys 4, and OK key 5 are provided near the display screen 21 as the user interface. Referring to FIG. 4, the operation of the functions of the portable information equipment will be described. Suppose that there are three hierarchical levels: major item selection, minor item selection, and individual item operation. To perform the function operation on the portable information equipment described above, the user first presses the menu key 3 to display a major item selection menu on the display screen 21 as shown in FIG. 4. In the example shown in FIG. 4, the major items such as “BASIC SETTING”, “MEDIA SETTING”, and so on are displayed in area R1 on the display screen 21 as a menu and, in the example, “SCENE” is selected from them. When there are too many items in the major item selection menus to be displayed on the display screen 21 at a time, a part of the menu is displayed. For example, the screen shown in FIG. 4 is the display screen 21 where a part of the major item selection menus is displayed.

In the major item selection menu shown in FIG. 4, any item selection method may be used. For example, an item initially in the vertical center may be used always as a selected item. Alternatively, when no item is selected initially, the user may press the OK key 5 to select the item initially in the center and, to select some other item, press the up or down arrow of the cross keys 4 to move the items up and down to bring a desired item to the center to select it.

For example, to perform operation on “PLAYLIST”, the user presses the down key of the cross keys 4 to change the center item to “PLAYLIST” so that the user can perform operation on “PLAYLIST”. Bringing “PLAYLIST” to the center causes the top item “BASIC SETTING” in the display screen 21 in FIG. 4 to disappear, and a menu item below “EFFECT” to appear at the bottom. In this example, because whether a desired item in the display screen 21 is above or below the center corresponds to the arrow direction of the cross keys 4, the user finds it easy to operate.

Because a menu item to be operated on is always in the vertical center of a plurality of menu items, the user can select the item to be operated on without moving the viewpoint. As shown in FIG. 4, an item to be operated on, which is located in the center and surrounded by the ellipse, is displayed in characters larger or darker than, or in a color different from, those of other items to emphasize the item to be operated on. In addition, in the example in FIG. 4, an icon ACs indicating an item is displayed to the left of each item with a larger icon ACb on the selected item.

This icon ACb may be changed to a rotating animated form for easier viewing. By rotating the icon ACb for a predetermined period after menu item selection or by rotating the icon ACb in a complete circle after item selection, the user can easily recognize that the item is selected.

It is preferable that both item names and icons ACs and ACb corresponding to the item names be displayed as menu items as in the first embodiment because the user finds those menu items easy to understand. If the user can understand the menu items, it is possible to display one of item names and the icons ACs and ACb corresponding to the item names.

A combination keypad of the cross keys 4 and the OK key 5, included in the operation unit 15, is located to the lower right of the display screen 21. This is because, when the portable information equipment is a shooting-type video camera 50 whose display 2 has the display screen 21 on the face opposite to the lens, the right-hand thumb comes right on the cross keys 4 and the OK key 5 when the user holds the video camera 50 with the hand in a grip belt 51 as shown in FIG. 7. The cross keys 4 and the OK key 5, provided in this position, are convenient to use because the user can perform many operations only with the right hand thumb.

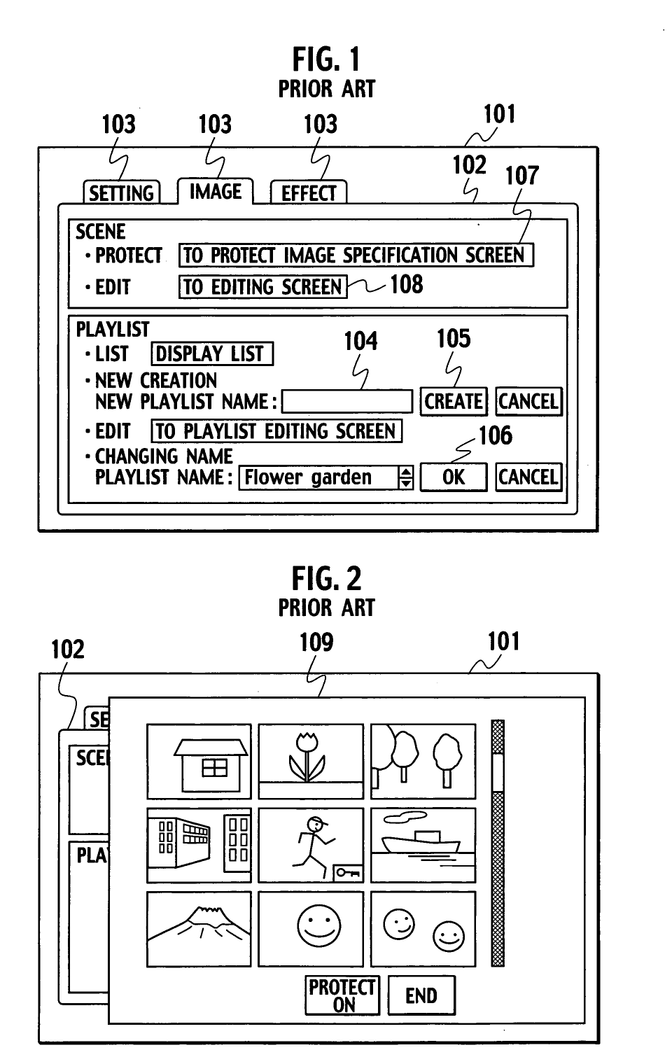

Note that the items displayed as intermediate items in FIG. 1 are displayed as major items in the example shown in FIG. 4. In this way, the itemization of items may be changed as necessary. Area R1, a large area in the display screen 21, can be used for displaying the items of the menu in the first embodiment. Therefore, the user can easily view rather many items even if they are displayed at a time in the display screen 21 that is relatively small.

In addition, in the example shown in FIG. 4, boundary line B1 is displayed near the right end of the display screen 21 as an example of a boundary image. This boundary line B1 divides the screen into two: a large area R1 positioned in the left side including the horizontal central part of the screen and a small area R2 positioned in the right side. The items of the major item selection menu, displayed as a list in area R1, represent a first hierarchical level. Area R2 contains a right-pointing triangle mark SR as an example of an identification image. This right-pointing triangle mark SR strongly suggests to the user that there is another hierarchical level (second hierarchical level) exists (that is, to the right). Because there is no left-pointing triangle mark to the left of area R1 and because there are the boundary line B1 and the right-pointing triangle mark SR at the right end of the display screen 21, the user can easily understand that the menu displayed in area R1 is at the first hierarchical level. In the example shown in FIG. 4, a part of a disc-shaped object is displayed as area R1.

When the user wants to perform operation on a minor item included in the major item “SCENE”, the user presses the right arrow of the cross keys 4 to give an instruction to go to the next hierarchical level. This instruction is predetermined by the program used by the microprocessor 14 of the portable information equipment. It is of course possible for the user to execute some other operating procedure; for example, the user presses the OK key 5 to confirm the selection of an item and then presses the right arrow of the cross keys 4. One or more keys provided in the operation unit 15 may be freely used to display an image at each hierarchical level.

An instruction to go to the next hierarchical level, if given by the user, causes the second hierarchical level such as the one shown in FIG. 5 to be displayed after the transition period that will be described later. In the example shown in FIG. 5, two items, “PROTECT” and “EDIT”, are displayed as minor menu items belonging to the major item “SCENE”, and “PROTECT” is selected in this example.

In the second hierarchical level screen shown in FIG. 5, boundary line B1, which was positioned near the right end on the first hierarchical level screen, moves to a position near the left end of the screen, and a new boundary line B2 appears at the right end. Preferably, boundary line B2 should be positioned at the position where boundary line B1 was displayed in FIG. 4. A left-pointing triangle mark SL is displayed to the left of boundary line B1 to indicate that there is a higher hierarchical level (first hierarchical level in this example). A right-pointing triangle mark SR is displayed to the right of boundary line B2 to indicate that there is a lower hierarchical level. In this display example, the multiple partially overlapped disc-shaped objects are displayed, one after the other. Area R1 to the left of boundary line B1, which is the topmost disc-shaped object, represents a part of the first hierarchical level to indicate that there is the first hierarchical level, and area R2 that is a large central area represents the second hierarchical level. Area R3 to the right of boundary line B2 represents a part of the third hierarchical level to indicate that there is a third hierarchical level.

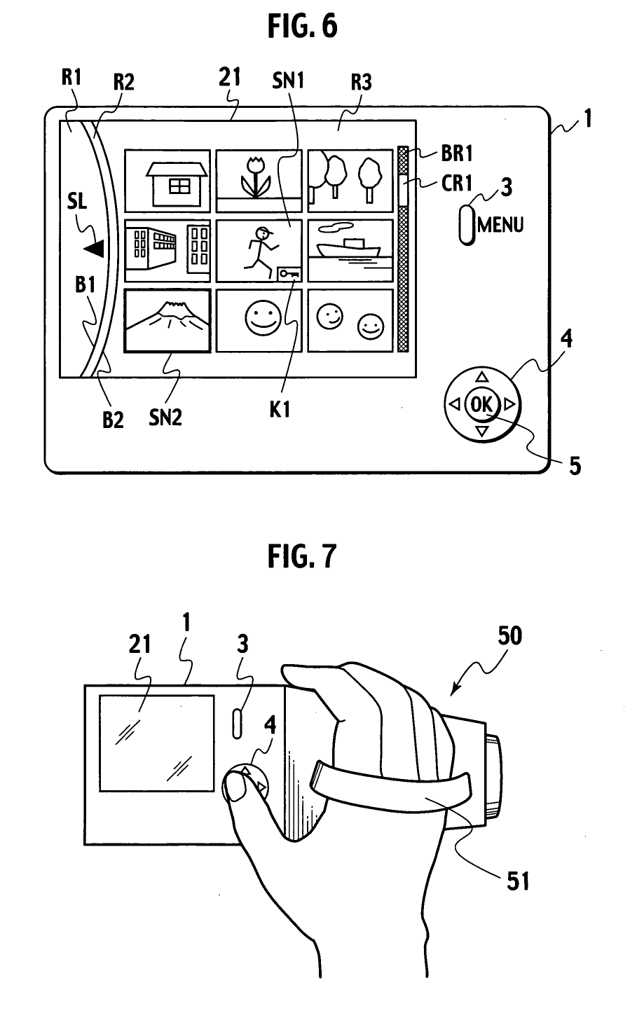

When the user selects “PROTECT” to give an instruction to go to the next hierarchical level in the same manner as described above for the first hierarchical level, the screen at the third hierarchical level such as the one shown in FIG. 6 is displayed. This is the last hierarchical level in this example and, for “PROTECT”, a plurality of thumbnail images of the images already recorded on the recording medium are displayed. While a multiple-item menu from which an item is selected is displayed at the first and second hierarchical levels, the operation screen for executing the function “PROTECT” is displayed at the third hierarchical level in the example shown in FIG. 6.

In the third hierarchical level screen shown in FIG. 6, boundary line B2 that was positioned near the right end of the screen at the second hierarchical level is moved to a position near boundary line B1 already displayed near the left end of the screen. That is, boundary line B1 at the third hierarchical level is displayed at the same position where boundary line B1 was displayed at the second hierarchical level. Boundary line B2 is moved to a position near to boundary line B1 in such a degree that they are very near but do not in contact with each other. Because two boundary lines, B1 and B2, are displayed near the left end of the screen of the display screen 21 with the left-pointing triangle mark SL to their left, the user can recognize that there are two higher hierarchical levels (first hierarchical level and the second hierarchical level in this example). The left-pointing triangle mark SL at the third hierarchical level is positioned at the same position where the left-pointing triangle mark SL was displayed at the second hierarchical level.

Although arc-shaped boundary lines, B1 and B2, are used as the boundary image and the triangle marks, SR and SL, are used as the identification image in the first embodiment, the boundary image and the identification image are not limited to those images. A straight boundary line and even anon-line image, which divides the display screen 21 into a plurality of areas, may also be used as the boundary image. An arrow or any other image, which lets the user know that there is a higher or lower hierarchical level, may also be used as the identification image.

Referring to the display example shown in FIG. 6, “PROTECT” is an item that prevents an image from being erased or changed as long as the same image is unprotected on this screen. The user selects one of the thumbnail images using the cross keys 4 and presses the OK key 5 to protect the corresponding image. As shown in the thumbnail image SN1 in the center, a mark such as a key mark K1 is inserted into a protected thumbnail image to tell the user that the image is protected. To unprotect a protected image, the user selects the thumbnail image of the protected image and presses the OK key 5 again.

As shown in a thumbnail image SN2 in the bottom left corner, a thick frame is displayed for the thumbnail image of a selected image. When the user uses the cross keys 4 to move into one of four directions, the selected image moves. When nine or more thumbnail images are recorded and the user presses the up key of the cross keys 4 with a thumbnail image in the top row selected, the images recorded before currently displayed images are displayed as thumbnail images; similarly, when the user presses the down key of the cross keys 4 with a thumbnail image in the bottom row selected, the images recorded after currently displayed images are displayed as thumbnail images.

Bar BR1 is displayed to the right of the thumbnail images. Cursor CR1, which is displayed as a white part in the bar, indicates the position of the currently displayed thumbnail images relative to the whole thumbnails including the hidden thumbnails.

To return the screen state shown in FIG. 6 to the one shown in FIG. 5 that is at the previous hierarchical level, the user presses the left key of the cross keys 4 with a thumbnail image in the leftmost column selected. Then, the screen returns to the one shown in FIG. 5 after a transition period that will be described later.

The operation screen has been described with “PROTECT” as an example. The operation screen is displayed also at the third hierarchical level for other functions (for example, “EDIT” in FIG. 5). However, note that thumbnail images are not always displayed at the third hierarchical level but a screen designed for each operation is displayed. Sometimes, the operation screen at the third hierarchical level displays a menu that is a list of multiple items. A menu composed of thumbnail images, such as those in the example of “PROTECT”, or multiple items at the third hierarchical level is referred to information corresponding to the third hierarchical level. The information here refers to any information including images and characters.

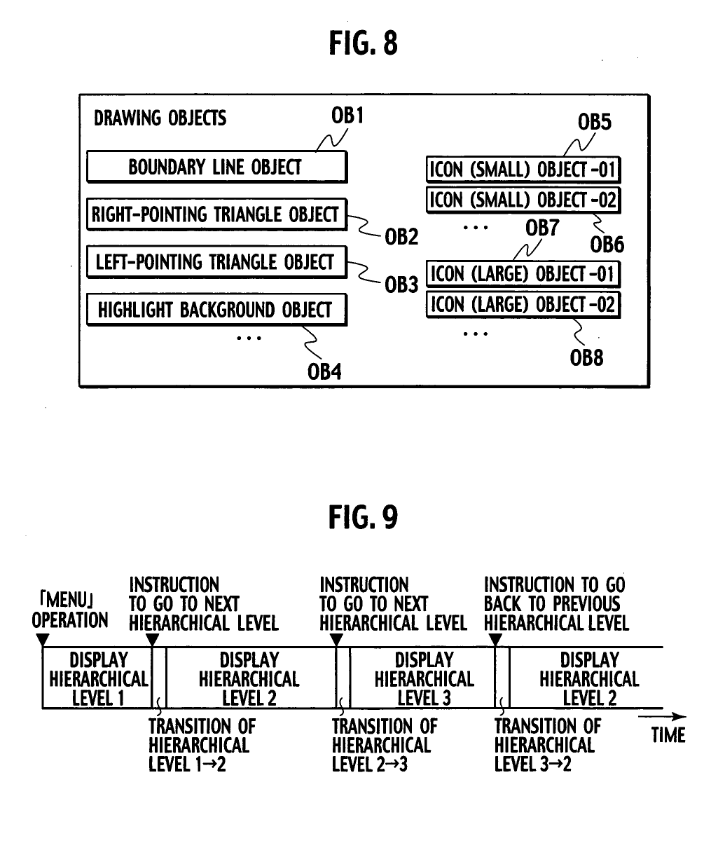

Programs and data used for displaying elements in the screen, such as boundary lines B1 and B2, the right-pointing triangle mark SR, and the left-pointing triangle mark SL, are called objects. Those elements themselves are sometimes called objects. FIG. 8 shows a list of major drawing objects required in the first embodiment. Boundary line object OB1 is an object for displaying boundary lines B1 and B2, right-pointing triangle object OB2 is an object for displaying the right-pointing triangle mark SR, left-pointing triangle object OB3 is an object for displaying the left-pointing triangle mark SL, and highlight background object OB4 is an object for displaying a bold frame on the thumbnail image SN2 shown in FIG. 6.

Icon (small) objects OB5, OB6, and so on are objects for displaying small icons ACs attached to the items of a menu, and icon (large) objects OB7, OB8, and so on are objects for displaying large icons ACb attached to an item selected from a menu. They are stored in the ROM 16 of portable information equipment as a part of programs and data for use in drawing processing by the microprocessor 14. The display screens shown in FIG. 4 to FIG. 6 are created by specifying parameter values (position, size, etc.) for those objects and displaying the drawing objects on the display screen 21 of the display 2.

<<Overview of Transition Among Hierarchical Levels>>

The following describes how the transition takes place among hierarchical levels. As described above, when the transition takes place from one hierarchical level to another, a new hierarchical level is displayed after the transition period required for displaying a predetermined image. FIG. 9 shows how this transition is performed. FIG. 9 shows an example of the operation process with the horizontal axis as the timeline.

Referring to FIG. 9, when the user first presses the menu key 3 to give an instruction to display the operation menu, the first hierarchical level (hierarchical level 1) is displayed and the user uses this screen to select an item from the menu. When the user gives an instruction to go to the next hierarchical level as described above, the transition image for going from the first hierarchical level to the second hierarchical level (hierarchical level 2) is displayed for a predetermined period and, after that, the second hierarchical level is displayed. The user uses this screen to perform operation on the second hierarchical level. When the user gives another instruction to go to the next hierarchical level, the transition image for going from the second hierarchical level to the third hierarchical level (hierarchical level 3) is displayed for a predetermined period and the third hierarchical level is displayed. When this hierarchical level is displayed, the user performs a desired operation. When the user gives an instruction to go back to the previous hierarchical level, the transition image for going from the third hierarchical level to the second hierarchical level is displayed for a predetermined period and the second hierarchical level is displayed again. The predetermined period for moving between hierarchical levels should be long enough for the user to recognize that the user transmits from one hierarchical level to another.

<<Operation During Transition Period>>

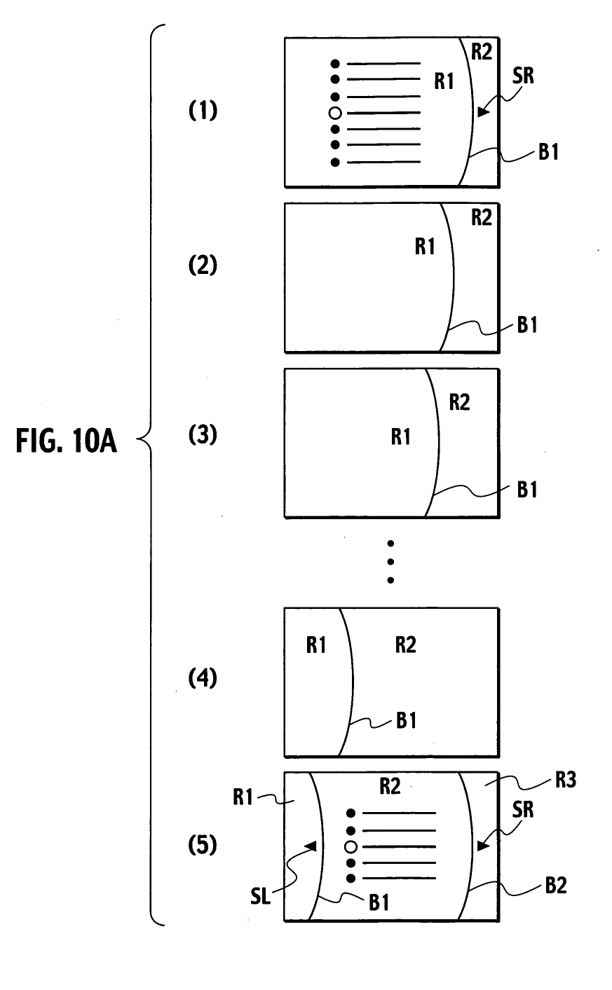

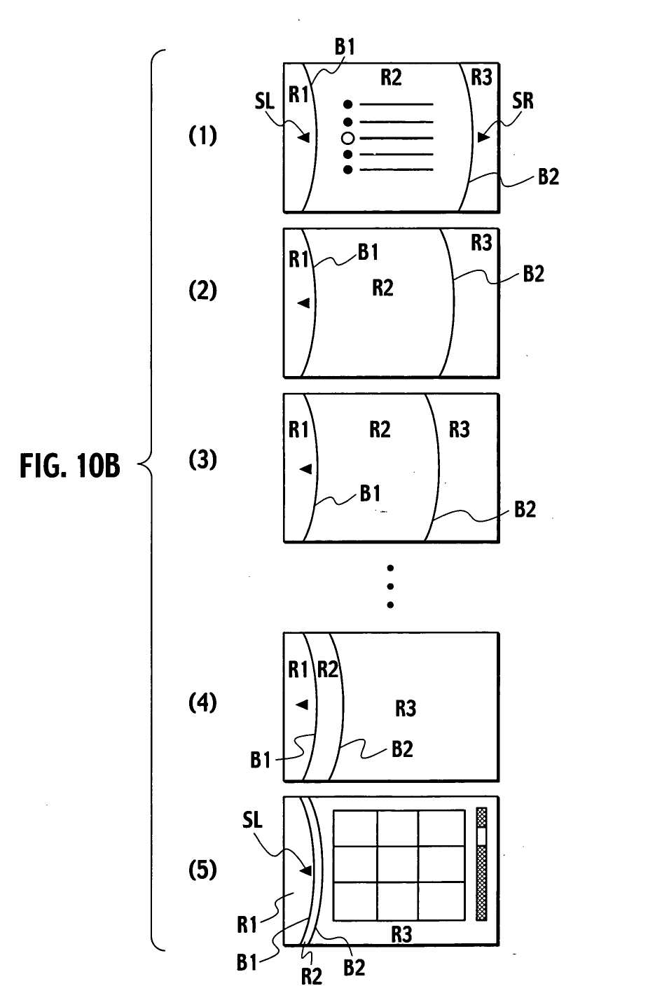

FIGS. 10A and 10B show how the screen changes during transition from one hierarchical level to another. FIG. 10A sequentially shows the transition from the first hierarchical level to the second hierarchical level using the illustrations (1) to (5), while FIG. 10B sequentially shows the transition from the second hierarchical level to the third hierarchical level using the illustrations (1) to (5). Note that the illustrations in FIG. 10A to FIG. 10B are simplified.

First, screen (1) in FIG. 10A, which is the first hierarchical level screen, corresponds to the screen shown in FIG. 4. The screen is divided into area R1 and area R2 by boundary line B1 displayed near the right end of the screen, with the menu items and icons (indicated by lines and points) displayed in the central area included in area R1. When the user gives an instruction to go to the next hierarchical level, boundary line B1 sequentially moves left, as shown in (2), (3), and (4) in FIG. 10A, until it reaches the position shown in (5). Screen (5) in FIG. 10A corresponds to the screen shown in FIG. 5. At this time, another boundary line B2 appears near the right end of the screen to divide area R2 into area R2 and area R3 and, at the same time, the left-pointing triangle mark SL and the right-pointing triangle mark SR are displayed. The second hierarchical level menu is displayed in area R2 that is in the center and is the largest among areas R1, R2, and R3 created by dividing as described above.

Screen (1) in FIG. 10B is the same as screen (5) in FIG. 10A. When the user gives an instruction to make a transition from the second hierarchical level shown in (1) in FIG. 10(B) to the third hierarchical level, boundary line B2 sequentially moves left as shown in (2), (3), and (4) in FIG. 10B until it reaches the position shown in (5). In this screen, boundary line B1 and boundary line B2 are displayed near to each other, and area R2 that comes between them becomes very small. As long as one hierarchical level can be identified between the hierarchical levels corresponding to areas R1 and R3, boundary line B1 and boundary line B2 can be displayed still nearer with area R2 displayed virtually as a line between boundary line B1 and boundary line B2. In (5) in FIG. 10B, the third hierarchical level screen (in this example, an image of nine thumbnail images) is displayed.

To make a transition from the third hierarchical level screen shown in (5) in FIG. 10B to the second hierarchical level screen shown in (1) in FIG. 10B, boundary line B2 sequentially moves right as shown in (4), (3), and (2) in FIG. 10B, in reverse order of the order described above, until it reaches the position shown in (1). Similarly, to make a transition from the second hierarchical level screen shown in (5) in FIG. 10A to the first hierarchical level screen shown in (1) in FIG. 10A, boundary line B1 sequentially moves right as shown in (4), (3), and (2) in FIG. 10A, in reverse order of the order described above, until it reaches the position shown in (1).

Boundary lines B1 and B2 move left or right as described above sequentially and gradually within a predetermined time on a pixel basis in the display screen 21. This continuous movement of boundary lines B1 and B2 allows the user to clearly identify that the hierarchical level is switched.

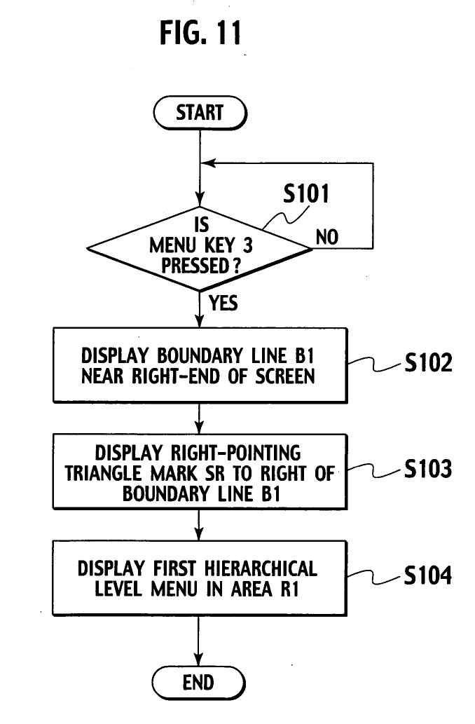

The following describes the transition period of drawing display on the screen by referring to the flowcharts. The flowcharts shown in FIGS. 11-13 are executed by the microprocessor 14.

First, FIG. 11 shows the flowchart of processing for displaying the first hierarchical level that is executed when the user presses the menu key 3 to give an instruction for displaying the menu. Referring to FIG. 11, whether the menu key 3 is pressed is checked in step S101. If it is detected that the menu key 3 is pressed, boundary line object OB1 displays boundary line B1 near the right end of the screen in step S102. In step s103, right-pointing triangle object OB2 displays the right-pointing triangle mark SR in area R2 that is right to the boundary line B1. In step S104, the first hierarchical level menu is displayed in area R1.

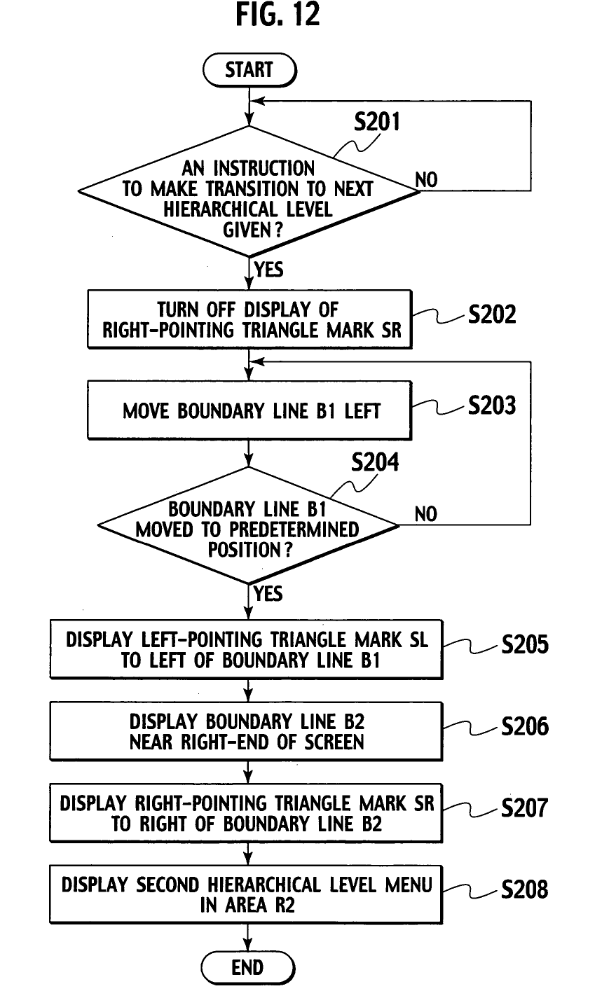

Next, the transition from the first hierarchical level to the second hierarchical level will be described with reference to the flowchart in FIG. 12. Referring to FIG. 12, the first hierarchical level is initially displayed as shown in FIG. 4 and, in step S201, whether an instruction to make a transition to the next hierarchical level is given is checked. If it is detected that this instruction is given, right-pointing triangle object OB2 turns off the display of the right-pointing triangle mark SR in step S202. In step S203, the display position of boundary line B1 is moved left at a predetermined speed as the time elapses by boundary line object OB1. In step S204, whether boundary line B1 is moved to a predetermined position in the left half of the screen by boundary line object OB1 is checked. If it is detected that the boundary line B1 is moved to that position, the movement is stopped. In step S205, left-pointing triangle object OB3 displays the left-pointing triangle mark SL in area R1 that is to the left of boundary line B1. In addition, in step S206, boundary line object OB1 displays boundary line B2 near the right-end of the screen and, in step S207, right-pointing triangle object OB2 displays the right-pointing triangle mark SR in area R3 that is to the right of boundary line B2. In step S208, the items of the second hierarchical level menu are displayed in area R2 that is the central part of the screen between boundary line B1 and boundary line B2.

During the transition from the first hierarchical level to the second hierarchical level described above, though the menu at the first hierarchical level may be erased at the same time the transition starts, it may also be moved left with the boundary line B1 and sequentially scrolled off from the screen. A part of the menu, if left unerased on the screen when the boundary line B1 reaches the final position, may also be erased at that time.

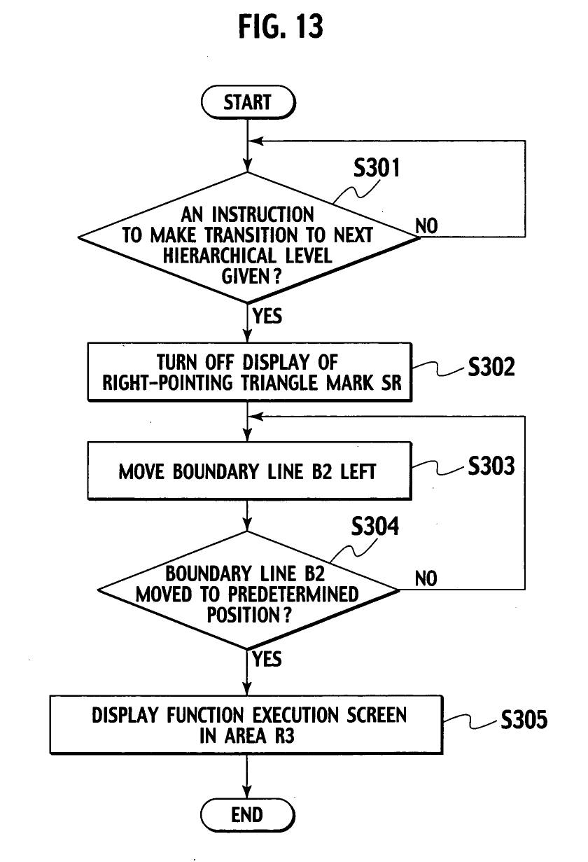

The transition from the second hierarchical level to the third hierarchical level will be described with reference to the flowchart in FIG. 13. Referring to FIG. 13, the second hierarchical level is displayed initially as shown in FIG. 5. In step S301, whether an instruction to make a transition to the next hierarchical level is given is checked. If it is detected that the instruction is given, right-pointing triangle object OB2 turns off the display of the right-pointing triangle mark SR in step S302. In step S303, the display position of boundary line B2 is moved left at a predetermined speed as the time elapses. In step S304, whether boundary line B2 is moved to the predetermined position (the position immediately to the right of boundary line B1) in the left hand side of the screen is checked. If it is detected that the boundary line B2 has moved to that position, the movement stops and, in step S305, the function execution screen (information corresponding to the third hierarchical level) is displayed in area R3 in the center of the screen.

The transition from the third hierarchical level (hierarchical level 3) to the second hierarchical level (hierarchical level 2) in FIG. 9 takes place in the reverse order of the steps in FIG. 13.

### Second Embodiment

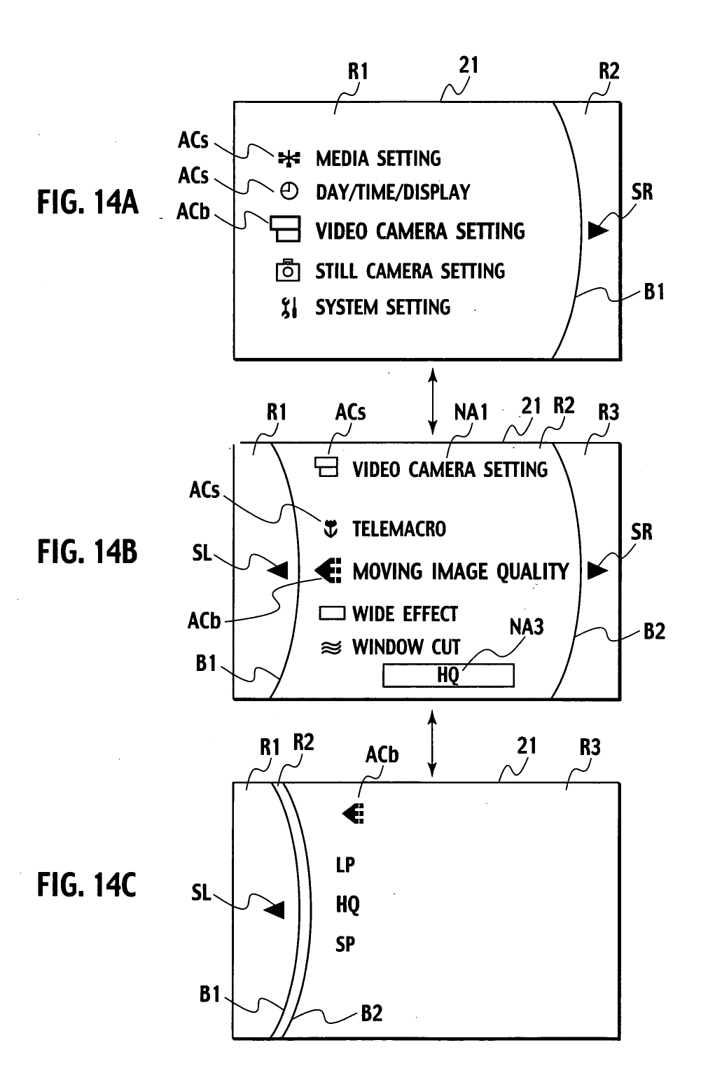

A second embodiment, an extension of the menu image display method in the first embodiment, allows the user to better understand the relation among the first hierarchical level to the third hierarchical level. The actual configuration of electronic information equipment for implementing the second embodiment is the same as that shown in FIG. 3. With reference to FIG. 14, the following describes only the characteristic part of the second embodiment.

FIG. 14A shows a first hierarchical level similar to that shown in FIG. 4, FIG. 14B shows a second hierarchical level menu similar to that shown in FIG. 5, and FIG. 14C shows third hierarchical level information similar to that shown in FIG. 6. The information at the third hierarchical level is not a thumbnail image such as the one shown in FIG. 6 but the setting information corresponding to the selected items (“Moving image quality” in this example).

The second embodiment is different from the first embodiment in the display of the second and third hierarchical levels shown in FIG. 14B and FIG. 14C. When the user selects the item “Video camera setting” in FIG. 14A, the screen makes a transition to that shown in FIG. 14B. As shown in FIG. 14B, the menu items at the second hierarchical level are displayed in area R2. In conjunction with the menu items at the second hierarchical level, the icon ACs and the item name NA1 (“Video camera setting” in this example), which is an item of the first hierarchical level menu corresponding to than the displayed second hierarchical level menu, are displayed.

Only the item name NA1 “Video camera setting” may be displayed; that is, at least one of the icon ACs and the item name NA1 should be displayed. The large icon ACb may also be displayed instead of the small icon ACs. This allows the user to easily identify the menu item at the first hierarchical level in which each item of the menu displayed at the second hierarchical level is included.

Furthermore, in conjunction with the menu items at the second hierarchical level, information at the third hierarchical level, which corresponds to the selected item (“Moving image quality” in this example), is displayed as setting information NA3. This allows the user to identify the setting information for the selected item without making a transition to the third hierarchical level. Note that the setting information NA3 need not be displayed for all the items at the second hierarchical level but only for items other than thumbnail images such as those shown in FIG. 6, that is, for an item selected as a setting value or setting status.

When the user selects “Moving image quality” as the item in FIG. 14B, the screen makes a transition to the one shown in FIG. 14C. As shown in FIG. 14C, the third hierarchical level information (setting information) is displayed in area R3. In conjunction with this third hierarchical level information, the icon ACb of the second hierarchical level menu item, which is information corresponding to the third hierarchical level currently displayed, is displayed.

As in the second hierarchical level, the icon ACb as well as the item name “Moving image quality” may also be displayed; that is, at least one of the icon ACb and the item name should be displayed. The small icon ACs may also be displayed instead of the large icon ACb. This allows the user to easily identify the menu item at the second hierarchical level to which the setting information displayed at the third hierarchical level belongs.

### Third Embodiment

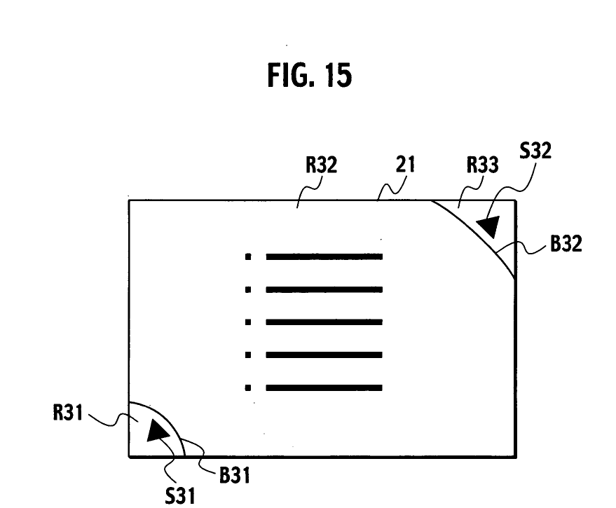

The first to third hierarchical levels are sequentially moved horizontally in the first and second embodiments, while the first to third hierarchical levels are sequentially moved diagonally in a third embodiment. The third embodiment is basically the same as the first embodiment. With reference to FIG. 15, the following describes only the characteristic parts of the third embodiment. FIG. 15 shows the display state at the second hierarchical level similar to that shown in FIG. 5.

Referring to FIG. 15, the display screen 21 is divided by boundary lines B31 and B32 into three areas. The lower left corner is area R31, the upper right corner is area R33, and the part between boundary line B31 and boundary line B32 is area R32. Triangle mark S31 is displayed in area R31, triangle mark S32 is displayed in area R33, and the menu items at the second hierarchical level are displayed in area R32. The transition from this state to the first hierarchical level is done by moving into the lower left direction, and the transition to the third hierarchical level by moving into the upper right direction. It is also possible to move into the reverse direction.

### Fourth Embodiment

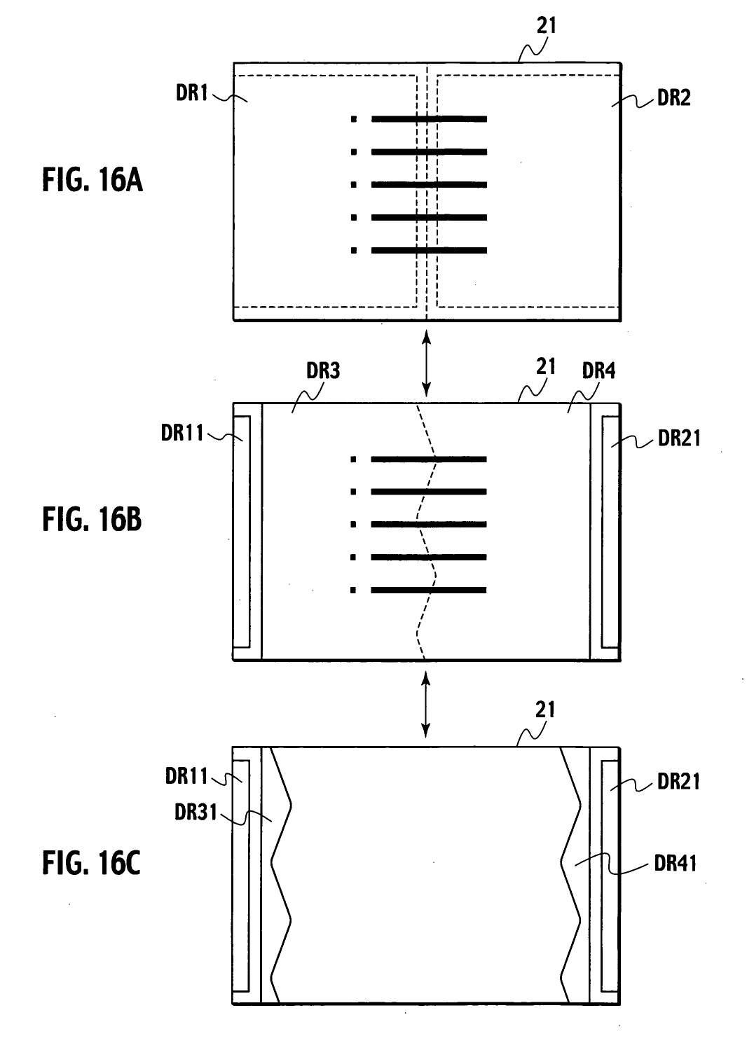

Instead of a part of a disc-shaped drawing object used in the first to third embodiments, a door-shaped drawing object is used in a fourth embodiment. FIG. 16A shows the first hierarchical level, FIG. 16B shows the second hierarchical level, and FIG. 16C shows the third hierarchical level.

Referring to FIG. 16A, doors DR1 and DR2 lightly drawn against the background are displayed in the display screen 21 as indicated by the broken lines. The first hierarchical level menu is displayed in the center of the display screen 21. When the user makes a transition to the second hierarchical level shown in FIG. 16B, doors DR1 and DR2 look pushed open and ends DR11 and DR21 of doors DR1 and DR2 are displayed on right and left ends of the display screen 21. In the second hierarchical level shown in FIG. 16B, doors DR3 and DR4 are also displayed lightly. The second hierarchical level menu is displayed in the center of the display screen 21. When the user makes a transition to the third hierarchical level shown in FIG. 16C, doors DR3 and DR4 look pushed open and ends DR31 and DR41 of doors DR3 and DR4 are displayed on right and left ends of the display screen 21.

In the fourth embodiment, the user can identify a hierarchical level by the number of doors opened right and left. To make a transition between hierarchical levels, for example, from the current hierarchical level to a lower hierarchical level, the doors, which were lightly drawn in the background, gradually opens while deeply displayed. To make a transition to a higher hierarchical level, the opened doors are closed and the closed doors are displayed lightly.

### Fifth Embodiment

Electronic information equipment in which the menu image display method according to the present invention is installed is not limited to portable information equipment such as the video camera 50 shown in FIG. 7. The menu image display method according to the present invention may be used in all types of electronic information equipment that display a menu image having a plurality of hierarchical levels on the display screen.

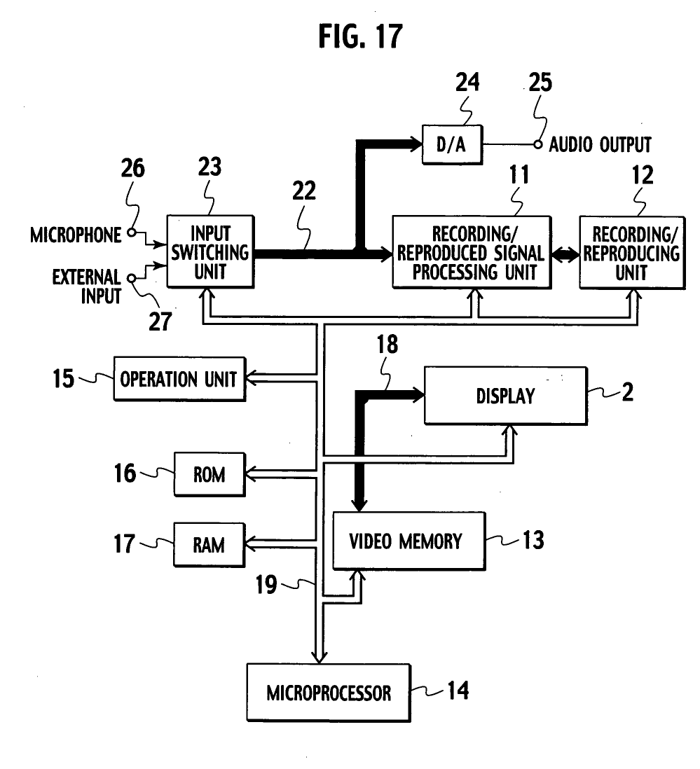

FIG. 17 is a block diagram showing a fifth embodiment in which the menu image display method according to the present invention is used in electronic information equipment other than the video camera 50. In FIG. 17, the same reference numerals are used for the corresponding elements of FIG. 3 and repetitive description will not be given.

Referring to FIG. 17, an input switching unit 23, a microphone input terminal 26 that works as an audio signal input terminal, and an external input terminal 27 are provided instead of the camera unit 10 in FIG. 3. A received audio signal is converted to a digital signal by an AD converter not shown and is supplied to an audio signal bus 22. Then, the audio signal is supplied to a recording/reproducing unit 12 via a recording/reproduced signal processing unit 11, which compresses the audio signal, for recording on a recording medium not shown.

The audio signal reproduced by the recording/reproducing unit 12 is decompressed by the recording/reproduced signal processing unit 11 and is output from an audio signal output terminal 25 via a D/A converter 24. The display signal from a video memory 13 is supplied to a display 2 via a video signal bus 18 and is converted to an analog signal by a display DA converter, not shown, for display on the display screen of the display 2. The display signal, which is a signal used to display information on a previously described operation screen (menu image at each hierarchical level), is created by a microprocessor 14 using the programs and data stored in a ROM 16.

### Sixth Embodiment

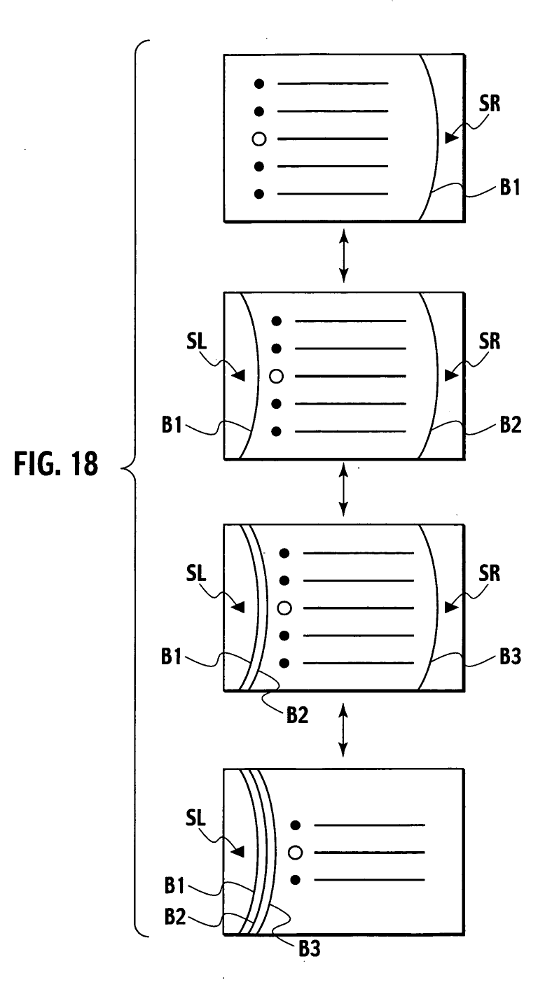

Although a menu image having three hierarchical levels is displayed in the first and second embodiments described above, the menu image can have four or more hierarchical levels. FIG. 18 schematically shows the transition among four hierarchical levels. The menu image having four hierarchical levels requires new boundary line B3 in addition to the boundary lines B1 and B2. Although not described in detail, the display and movement rules for the boundary lines B1-B3, right-pointing triangle mark SR, and left-pointing triangle mark SL are the same as those in the first and second embodiments.

It should be understood that many modifications and adaptations of the invention will become apparent to those skilled in the art and it is intended to encompass such obvious modifications and changes in the scope of the claims appended hereto.

What is claimed is:

1. A menu image display method for displaying a menu image on a screen, said menu image composed of a plurality of hierarchical levels, said method comprising the steps of:
in response to a key operation for displaying a first hierarchical level menu on the screen, displaying a first boundary image and a first identification image, which indicates that there is a second hierarchical level lower than said first hierarchical level, on the screen and, at the same time, generating a first display state in which a plurality of items constituting said first hierarchical level menu are displayed in one of areas delimited by said first boundary image on the screen;
in response to a key operation for selecting one of said plurality of items constituting said first hierarchical level menu to make a transition to said second hierarchical level, displaying second and third boundary images, a second identification image which indicates that there is said first hierarchical level, and a third identification image which indicates that there is a third hierarchical level lower than said second hierarchical level on the screen and, at the same time, generating a second display state in which a plurality of items constituting said second hierarchical level menu are displayed in a first intermediate area appearing between said second and third boundary images; and
in response to a key operation for selecting one of said plurality of items constituting said second hierarchical level menu to make a transition to said third hierarchical level, displaying fourth and fifth boundary images, which are near but not in contact each other, and a fourth identification image which indicates that there is a hierarchical level higher than said third hierarchical level on the screen and, at the same time, generating a third display state in which information corresponding to said third hierarchical level is displayed in an area other than a second intermediate area appearing between said fourth and fifth boundary images.

2. The menu image display method according to claim 1 wherein, when a transition occurs from said first display state to said second display state, said first boundary image is moved on the screen to change into said second boundary image.

3. The menu image display method according to claim 2 wherein said third boundary image is displayed at the same position as said first boundary image.

4. The menu image display method according to claim 1 wherein said fourth boundary image is displayed at the same position as said second boundary image.

5. The menu image display method according to claim 4 wherein, when a transition occurs from said second display state to said third display state, said third boundary image is moved on the screen to change into said fifth boundary image.

6. The menu image display method according to claim 1 wherein, in said first display state, said first identification image is displayed in a first outer area which is another area delimited by said first boundary image on the screen, and in which said plurality of items constituting said first hierarchical level menu are not displayed.

7. The menu image display method according to claim 6 wherein, in said second display state, said second identification image is displayed in a second outer area positioned outside said first intermediate area and said third identification image is displayed in the same position as said first identification image in a third outer area that is opposed to said second outer area across said intermediate area.

8. The menu image display method according to claim 7 wherein, in said third display state, said fourth identification image is displayed in the same position as said second identification image in a fourth outer area which is positioned outside said second intermediate area and in which information corresponding to said third hierarchical level is not displayed.

9. The menu image display method according to claim 1 wherein, in said first and second display states, at least one of an item name of each item and an icon corresponding to the item name is displayed as said plurality of items and,
in said second display state, at least one of an item name and an icon of an item in said first hierarchical level menu is also displayed, said item corresponding to said plurality of items in said second hierarchical level menu.

10. The menu image display method according to claim 9 wherein, in said second display state, information at said third hierarchical level is also displayed, said information corresponding to an item selected from said plurality of items.

11. Electronic information equipment comprising a display screen for displaying a menu image on the display screen, said menu image composed of a plurality of hierarchical levels, said equipment comprising:
an operation unit having one or more keys;
first display means that, in response to a key operation activated by one of the keys on said operation unit for displaying a first hierarchical level menu on the screen, displays a first boundary image and a first identification image, which indicates that there is a second hierarchical level lower than said first hierarchical level, on the display screen and, at the same time, generates a first display state in which a plurality of items constituting said first hierarchical level menu are displayed in one of areas delimited by said first boundary image on the display screen;
second display means that, in response to a key operation activated by one of the keys on said operation unit for selecting one of said plurality of items constituting said first hierarchical level menu to make a transition to said second hierarchical level, displays second and third boundary images, a second identification image which indicates that there is said first hierarchical level, and a third identification image which indicates that there is a third hierarchical level lower than said second hierarchical level on the display screen and, at the same time, generates a second display state in which a plurality of items constituting said second hierarchical level menu are displayed in a first intermediate area appearing between said second and third boundary images; and
third display means that, in response to a key operation activated by one of the keys on said operation unit for selecting one of said plurality of items constituting said second hierarchical level menu to make a transition to said third hierarchical level, displays fourth and fifth boundary images, which are near but not in contact each other, and a fourth identification image which indicates that there is a hierarchical level higher than said third hierarchical level on the display screen and, at the same time, generates a third display state in which information corresponding to said third hierarchical level is displayed in an area other than a second intermediate area appearing between said fourth and fifth boundary images.

12. The electronic information equipment according to claim 11, further comprising first boundary image moving means for moving said first boundary image on the display screen to change said first boundary image into said second boundary image when a transition occurs from said first display state to said second display state.

13. The electronic information equipment according to claim 12 wherein said second display means displays said third boundary image at the same position as said first boundary image.

14. The electronic information equipment according to claim 11 wherein said third display means displays said fourth boundary image at the same position as said second boundary image.

15. The electronic information equipment according to claim 14, further comprising second boundary image moving means for moving said third boundary image on the screen to change said third boundary image into said fifth boundary image when a transition occurs from said second display state to said third display state.

16. The electronic information equipment according to claim 11 wherein said first display means displays said first identification image in a first outer area which is another area delimited by said first boundary image on the screen, and in which said plurality of items constituting said first hierarchical level menu are not displayed.

17. The electronic information equipment according to claim 16 wherein said second display means displays said second identification image in a second outer area positioned outside said first intermediate area and displays said third identification image in the same position as said first identification image in a third outer area that is opposed to said second outer area across said intermediate area.

18. The electronic information equipment according to claim 17 wherein said third display means displays said fourth identification image in the same position as said second identification image in a fourth outer area which is positioned outside said second intermediate area and in which information corresponding to said third hierarchical level is not displayed.

19. The electronic information equipment according to claim 11 wherein said first and second display means display at least one of an item name of each item and an icon corresponding to the item name as said plurality of items and,
said second display means also displays at least one of an item name and an icon of an item in said first hierarchical level menu, said item corresponding to said plurality of items in said second hierarchical level menu.

20. The electronic information equipment according to claim 19 wherein said second display means also displays information at said third hierarchical level, said information corresponding to an item selected from said plurality of items.
